(19) United States
(12) Patent Application Publication
(10) Pub. No.: US 2026/0110285 A1
(43) Pub. Date: Apr. 23, 2026

(54) IGNITION SYSTEM

(71) Applicant: Volvo Truck Corporation, Göteborg (SE)

(72) Inventors: Rafig Babayev, Göteborg (SE); Joop Somhorst, Göteborg (SE)

(21) Appl. No.: 19/351,457

(22) Filed: Oct. 7, 2025

(30) Foreign Application Priority Data
Oct. 22, 2024 (EP) 24208071.1

(51) Int. Cl. F02P 15/00; F02D 1/02; F02D 41/40; F02D 43/04

(52) U.S. Cl. CPC F02P 15/006; F02D 1/02; F02D 41/40; F02D 43/04

(57) ABSTRACT

An ignition system including an injection member configured to deliver fuel to an ignition zone within a combustion chamber, an ignition element configured to ignite fuel within the ignition zone, and a control unit configured to operate the injection member and the ignition element in a first ignition phase including ignition of a first delivery of fuel provided to the combustion chamber by the injection member and a second ignition phase including ignition of a second delivery of fuel provided to the combustion chamber by the injection member.

### PRIORITY APPLICATIONS

The present application claims priority to European Patent Application No. 24208071.1, filed on Oct. 22, 2024, and entitled “IGNITION SYSTEM,” which is incorporated herein by reference in its entirety.

### TECHNICAL FIELD

The disclosure relates generally to vehicles. In particular aspects, the disclosure relates to an ignition system configured for use on a vehicle.

The disclosure may relate to heavy-duty vehicles, such as trucks, buses, and/or construction equipment, among other vehicle types. However, although the disclosure may be described with respect to a particular vehicle, the disclosure is not restricted to any particular vehicle.

### BACKGROUND

An engine of a vehicle, such as an internal combustion engine and/or hybrid internal combustion engine, typically includes an engine block defining one or more cylinder configured for reciprocation of a piston, which together form a combustion chamber. A fuel, such aa hydrogen-based fuel and/or hydrocarbon-based fuel, is mixed with air and ignited in the combustion chamber. Pressure produced from combustion of the fuel mixed with air applies force on the piston, thereby converting chemical energy to mechanical energy.

Utilizing hydrogen-based fuel in an internal combustion engine and/or a hybrid internal combustion engine has become a leading option for reducing harmful emission of pollutants, such as hydrocarbons, nitric oxide, nitrogen dioxide, and/or the like. Reducing harmful emission of pollutants allows for improvement of the environment and for meeting criteria imposed by zero-emission vehicle standards, which are directed at reducing and/or eliminating emission of waste product that pollutes the environment and/or disrupts the climate. However, ignition of hydrogen-based fuel has drawbacks, such as ignition resistance related to hydrogen-based fuel having a relatively low cetane rating, which is an indicator of a speed of combustion of a fuel for ignition, when compared to that of hydrocarbon-based fuel, such as diesel fuel, which has a relatively high cetane rating.

Currently available systems for igniting hydrogen-based fuel in an internal combustion engine and/or a hybrid internal combustion engine typically include employing a pilot injection of diesel fuel delivered to the combustion chamber, prior to an injection of hydrogen-based fuel delivered to the combustion chamber, to facilitate ignition and/or reduce ignition delay of hydrogen-based fuel. However, employing diesel fuel increases harmful emission of pollutants and, thus, is detrimental to improving the environment and meeting criteria imposed for meeting zero-emission vehicle standards.

It is desirable to provide an ignition system configured for use on a vehicle that is configured to facilitate ignition of fuel in an internal combustion engine and/or hybrid internal combustion engine, without a pilot injection of hydrocarbon-based fuel to facilitate ignition of the fuel, thereby reducing emission of harmful pollutants and, thus, improving the environment and meeting criteria imposed by zero-emission vehicle standards.

### SUMMARY

According to aspects of the disclosure, an ignition system configured for use on a vehicle is provided. According to aspects of the disclosure, the control unit may be configured to operate the power unit in the first measurement phase at a first time and the second measurement phase at a second time.

According to aspects of the disclosure, an ignition system configured for use on a vehicle is provided. The vehicle includes a power unit including one or more combustion chamber. The ignition system includes an injection member configured to deliver fuel to an ignition zone within the combustion chamber, an ignition element configured to ignite fuel within the ignition zone, and a control unit configured to operate the injection member and the ignition element in a first ignition phase including ignition of a first delivery of fuel provided to the combustion chamber by the injection member and a second ignition phase including ignition of a second delivery of fuel provided to the combustion chamber by the injection member.

According to aspects of the disclosure, the control unit may be configured to operate the injection member to deliver a first amount of fuel in the first delivery of the first ignition phase and to deliver a second amount of fuel in the second delivery of the second ignition phase.

According to aspects of the disclosure, the second amount of fuel delivered in the second delivery of the second ignition phase may be greater than the first amount of fuel delivered in the first delivery of the first ignition phase.

According to aspects of the disclosure, the control unit may be configured to operate the injection member and the ignition element in the first ignition phase at a first time and the second ignition phase at a second time.

According to aspects of the disclosure, the first time of the first ignition phase and the second time of the second ignition phase may be successive.

According to aspects of the disclosure, the first time of the first ignition phase may correspond to an intake stroke of the combustion chamber.

According to aspects of the disclosure, the first time of the first ignition phase may correspond to a compression stroke of the combustion chamber.

According to aspects of the disclosure, the second time of the second ignition phase may correspond to a power stroke of the combustion chamber.

According to aspects of the disclosure, the injection member and the ignition element may be configured to form the ignition zone within an area corresponding to 50% or less of a diameter of the combustion chamber.

According to aspects of the disclosure, the ignition element may extend to a tip having an ignition surface configured to be in contact with fuel delivered to the combustion chamber.

According to aspects of the disclosure, the ignition element may include a coating applied to the ignition surface of the tip of the ignition element, the coating including a catalyst configured to facilitate ignition of fuel delivered to the combustion chamber.

According to aspects of the disclosure, the ignition element may be configured to generate a spark to ignite fuel delivered to the combustion chamber.

According to aspects of the disclosure, the injection member may extend to a head defining a plurality of outlets configured to direct fuel to the combustion chamber.

According to aspects of the disclosure, the plurality of outlets of the head of the injection member may be oriented circumferentially about the head of the injection member.

According to aspects of the disclosure, one or more outlet of the plurality of outlets may include a conical geometry.

According to aspects of the disclosure, the ignition system may include an intake port configured to provide air to the combustion chamber and one or more of the intake port and the combustion chamber may be configured to swirl an air-fuel mixture within the combustion chamber.

According to aspects of the disclosure, a vehicle is provided. The vehicle includes a power unit including one or more combustion chamber and the ignition system according to any aspect of the disclosure presented herein.

According to aspects of the disclosure, the power unit may include an intake port configured to deliver a flow air to the combustion chamber and one or more of the intake port and the combustion chamber may be configured to swirl an air-fuel mixture within the combustion chamber.

According to aspects of the disclosure, a method for ignition of fuel for a vehicle is provided. The vehicle includes a power unit including one or more combustion chamber. The method includes providing the ignition system according to any aspect of the disclosure presented herein and operating the injection member and the ignition element in the first ignition phase including the first delivery of fuel to the combustion chamber and the second ignition phase including the second delivery of fuel to the combustion chamber.

According to aspects of the disclosure, the method may include determining one or more of an amount of fuel and a duration of delivery of fuel delivered in the first delivery of the first ignition phase.

In the manner described and according to aspects illustrated herein, the ignition system, the vehicle, and the method for ignition of fuel for a vehicle are configured to facilitate ignition of a fuel in an internal combustion engine and/or hybrid internal combustion engine, without a pilot injection of a hydrocarbon-based fuel to facilitate ignition of fuel, to thereby reduce emission of harmful pollutants and, thus, improve the environment and meet criteria imposed by zero-emission vehicle standards.

The disclosed aspects, examples (including any preferred examples), and/or accompanying claims may be suitably combined with each other as would be apparent to a person having ordinary skill in the art. Additional features and advantages are disclosed in the following description, claims, and drawings, and in part will be readily apparent therefrom to persons skilled in the art and/or recognized by practicing the disclosure as described herein.

### BRIEF DESCRIPTION OF THE DRAWINGS

Aspects of the disclosure will be described with reference to the drawings, where like numerals reflect like elements:

FIG. 1 shows a side perspective view of a vehicle according to aspects of the disclosure;

FIG. 2 shows a side perspective view of a power unit of the vehicle of FIG. 1 according to aspects of the disclosure;

FIG. 3 shows a schematic front cross-sectional view of an ignition system configured for use on the vehicle of FIG. 1, within a combustion chamber of the power unit of FIG. 2 according to aspects of the disclosure;

FIG. 4A shows a front perspective view of the combustion chamber of FIG. 3 according to aspects of the disclosure;

FIG. 4B shows a front perspective view of an alternative arrangement of the combustion chamber of FIG. 3 according to aspects of the disclosure;

FIG. 5 shows a front perspective view of a head of an injection member of the ignition system of FIG. 3 according to aspects of the disclosure;

FIG. 6 shows a schematic diagram of the ignition system of FIG. 3 according to aspects of the disclosure;

FIG. 7A shows a bottom perspective view of the ignition system of FIG. 3, depicting operation of the injection member and an ignition element in a first ignition phase according to aspects of the disclosure;

FIG. 7B shows a bottom perspective view of the ignition system of FIG. 3, depicting operation of the injection member and the ignition element of the ignition system in the first ignition phase according to aspects of the disclosure;

FIG. 7C shows a bottom perspective view of the ignition system of FIG. 3, depicting operation of the injection member and the ignition element of the ignition system in a second ignition phase according to aspects of the disclosure; and

FIG. 7D shows a bottom perspective view of the ignition system of FIG. 3, depicting operation of the injection member and the ignition element of the ignition system in the second ignition phase according to aspects of the disclosure.

### DETAILED DESCRIPTION

The detailed description set forth below provides information and examples with sufficient detail to enable those skilled in the art to practice the disclosure.

In the description, like numerals represent like parts. Although the technology disclosed herein is described with reference to specific examples, it should be understood that modifications and changes may be made to these examples without going beyond the general scope as defined by the claims. In particular, individual characteristics of the various examples shown and/or mentioned herein may be combined in additional examples. Consequently, the description and the drawings should be considered in a sense that is illustrative rather than restrictive. The Figures, which are not necessarily to scale, depict illustrative aspects and are not intended to limit the scope of the disclosure. The illustrative aspects depicted are intended only as exemplary.

The term “exemplary” is used in the sense of “example,” rather than “ideal.” While aspects of the disclosure are amenable to various modifications and alternative forms, specifics thereof have been shown by way of example in the drawings and will be described in detail. It should be understood, however, that the intention is not to limit aspects of the disclosure to a particular example described. On the contrary, the intention of this disclosure is to cover all modifications, equivalents, and alternatives falling within the scope of the disclosure.

Various materials, methods of construction, methods of fastening, and the like may be described in the context of disclosed examples. Those skilled in the art will recognize known substitutes for the materials, construction methods, fastening methods, and the like, all of which are contemplated as compatible with the disclosed example and are intended to be encompassed by the appended claims.

As used in this disclosure and the appended claims, the singular forms “a,” “an,” and “the” include plural referents, unless the content clearly dictates otherwise. As used in this disclosure and the appended claims, the term “or” is generally employed in a sense including “and/or,” unless the content clearly dictates otherwise.

Throughout the description, including the claims, the terms “comprising a,” “including a,” and “having a” should be understood as being synonymous with “comprising one or more,” “including one or more,” and “having one or more” unless otherwise stated. In addition, any range set forth in the description, including the claims, should be understood as including its end value(s), unless otherwise stated. Specific values for described elements should be understood to be within accepted manufacturing or industry tolerances known to one of skill in the art, and any use of the terms “substantially,” “approximately,” and “generally” should be understood to mean falling within such accepted tolerances.

When an element or feature is referred to herein as being “on,” “engaged to,” “connected to,” or “coupled to” another element or feature, it may be directly on, engaged, connected, or coupled to the other element or feature, or intervening elements or features may be present. In contrast, when an element or feature is referred to herein as being “directly on,” “directly engaged to,” “directly connected to,” or “directly coupled to” another element or feature, there may be no intervening elements or features present. Other words used to describe the relationship between elements or features should be interpreted in a like manner (e.g., “between” versus “directly between,” “adjacent” versus “directly adjacent,” etc.).

Spatially relative terms, such as “top,” “bottom,” “middle,” “inner,” “outer,” “beneath,” “below,” “lower,” “above,” “upper,” and the like may be used herein for ease of description to describe one element or relationship of a feature to another element(s) or feature(s) as illustrated in the drawings. Spatially relative terms may be intended to encompass different orientations of a device in use or operation in addition to the orientation depicted in the drawings. For example, if the device in the drawings is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although the terms “first,” “second,” “third,” etc. may be used herein to describe various elements, components, regions, layers, sections, and/or parameters, these elements, components, regions, layers, sections, and/or parameters should not be limited by these terms. These terms are only used to distinguish one element, component, region, layer, section, or parameter from another element, component, region, layer, section, or parameter. Thus, a first element, component, region, layer, section, or parameter discussed herein could be termed a second element, component, region, layer, section, or parameter without departing from the teachings of the present disclosure.

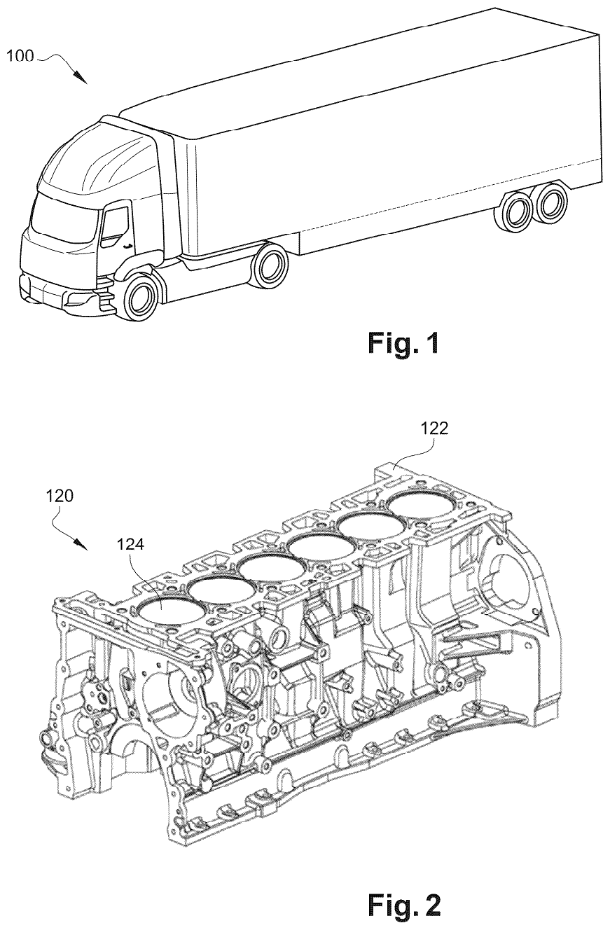

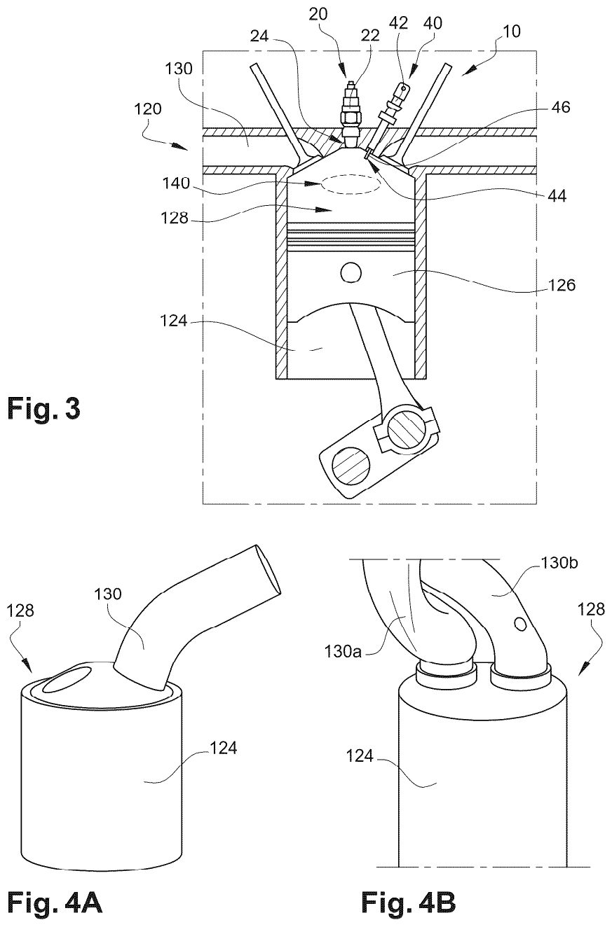

FIGS. 3-6 show an ignition system 10 configured for use on a vehicle 100. Additionally or alternatively, it is contemplated that the ignition system 10 may be considered and/or referred to as being included by the vehicle 100. Referring to FIG. 1, it is contemplated that the vehicle 100 may be a heavy-duty vehicle, such as a truck, bus, and/or construction equipment. However, it should be understood that the ignition system 10 may be configured for use on other types of vehicles. It is contemplated that the ignition system 10 may be configured for use on an internal combustion engine vehicle. Additionally or alternatively, it is contemplated that the ignition system 10 may be configured for use on a hybrid internal combustion engine-battery electric vehicle and/or a hybrid internal combustion engine-fuel cell electric vehicle. Reference to an internal combustion engine vehicle will be used herein, unless reference to a hybrid internal combustion engine-battery electric vehicle, a hybrid internal combustion engine-fuel cell electric vehicle, and/or the like is otherwise necessary.

Referring to FIGS. 2-4B, the vehicle 100 to which the ignition system 10 is configured for use on includes a power unit 120. Additionally or alternatively, the power unit 120 may be considered and/or referred to as being included by the ignition system 10. Additionally or alternatively, the ignition system 10 may be considered and/or referred to as being included by the power unit 120. It is contemplated that the power unit 120 may be considered and/or referred to herein as an internal combustion engine. In examples, the power unit 120 may be in the form of a hydrogen internal combustion engine configured to utilize hydrogen as a primary source of fuel for combustion. In particular, hydrogen may be utilized as the primary source of fuel in combination with air as an air-fuel mixture used for combustion. Additionally or alternatively, the power unit 120 may be in the form of a hydrocarbon internal combustion engine configured to utilize hydrocarbon as a primary source of fuel for combustion. In particular, hydrocarbon may be utilized as the primary source of fuel in combination with air as an air-fuel mixture used for combustion. Reference to the power unit 120 being in the form of a hydrogen internal combustion engine will be used herein, unless reference to the power unit 120 being in the form of a hydrocarbon internal combustion engine and/or the like is otherwise necessary.

It is contemplated that the vehicle 100 to which the ignition system 10 is configured for use on includes a fuel supply source (not shown) configured to store fuel and to deliver fuel to one or more of the ignition system 10 and the power unit 120 (i.e. to one or more of an injection member 20 included by the ignition system 10 and a combustion chamber 128 included by the power unit 120).

As shown in FIGS. 2-3, the power unit 120 may include an engine block 122 defining one or more cylinder 124. The cylinder 124 is configured to receive a piston 126. Additionally or alternatively, the cylinder 124 is configured for reciprocation of the piston 126 within the cylinder 124. The cylinder 124 and the piston 126 are configured to form a combustion chamber 128. The combustion chamber 128 is configured for combustion of the air-fuel mixture.

It is contemplated that combustion of the air-fuel mixture generates mechanical energy. In particular, it is contemplated that the combustion chamber 128 and, thus, the power unit 120, is configured for performance of a plurality of strokes corresponding to reciprocation of the piston 126 within the cylinder 124 to generate mechanical energy. The combustion chamber 128 is configured for performance of a first stroke (may also be referred to herein as an “intake stroke”) including the piston 126 beginning at a top dead center position (may also be referred to herein as “TDC”) within the cylinder 124 and ending at a bottom dead center position (may also be referred to herein as “BDC”) to generate suction to draw the air-fuel mixture into the combustion chamber 128. The combustion chamber 128 is configured for performance of a second stroke (may also be referred to herein as a “compression stroke”) including the piston 126 beginning at the bottom dead center position, and/or at the end of the first stroke, and ending at the top dead center position to compress the air-fuel mixture to prepare for ignition of the air-fuel mixture. The combustion chamber 128 is configured for performance of a third stroke (may also be referred to herein as a “power stroke”) including the piston 126 beginning at the top dead center position, and/or at the end of the second stroke, and ending at the bottom dead center position due to force applied on the piston 126 by ignition of the compressed air-fuel mixture, thereby generating mechanical energy. The combustion chamber 128 is configured for performance of a fourth stroke (may also be referred to herein as an “exhaust stroke”) including the piston 126 beginning at the bottom dead center position, and/or at the end of the third stroke, and ending at the top dead center position to expel spent air-fuel mixture from the combustion chamber 128. In this manner, the combustion chamber 128 and, thus, the power unit 120, is configured to generate mechanical energy to propel the vehicle 100 and/or to be converted and stored as electrical energy.

As shown in FIGS. 3-4B, the ignition system 10 may include one or more intake port 130 configured to be in communication with the combustion chamber 128. The intake port 130 is configured to provide air to the combustion chamber 128 for the air-fuel mixture used for combustion. Additionally or alternatively, it is contemplated that the intake port 130 may be considered and/or referred to herein as being included by the combustion chamber 128 and, thus, the power unit 120. One or more of the intake port 130 and the combustion chamber 128 may be configured for generating swirl and/or tumble (i.e. rotational motion) of the air-fuel mixture. In examples, one or more of the intake port 130 and the combustion chamber 128 may be configured for generating swirl and/or tumble of the air-fuel mixture having a rotational speed within a range of 1 rotation and 5 rotations of the air-fuel mixture in the combustion chamber 128 per rotation of a crankshaft (not shown) of the power unit 120. The intake port 130 may include one or more of a helical geometry, a tangential geometry, and/or the like configured to initiate an angular momentum of the air provided to the combustion chamber 128. Accordingly, the intake port 130 may be configured to function as, considered to be in the form of, and/or referred to as a “helical intake port” and/or a “tangential intake port.” Referring to FIG. 4B, the ignition system 10 may include at least a first intake port 130a and a second intake port 130b. The first intake port 130a may include a helical geometry and the second intake port 130b may include a tangential geometry. Additionally or alternatively, it is contemplated that the combustion chamber 128 may include a plurality of vanes (not shown) (may also be referred to herein as “swirler vanes”) configured to initiate angular momentum of the air-fuel mixture to generate swirl and/or tumble of the air-fuel mixture. In this manner, the ignition system 10 may be configured to enhance mixing of the air-fuel mixture, ignition propagation (may also be referred to herein as “flame propagation”), and combustion speed and efficiency within the combustion chamber 128. Additionally, in this manner, the ignition system 10 may be configured to reduce an overflow of fuel in a direction toward an ignition element 40 (described in further detail below) of the ignition system 10 and, thus, an overheating of the ignition element 40.

In examples, the engine block 122 may define a plurality of cylinders 124 and may include a plurality of pistons 126 and each cylinder 124 of the plurality of cylinders 124 is configured for reciprocation of a corresponding piston 126 of the plurality of pistons 126. The plurality of cylinders 124 and the plurality of pistons 126 are configured to form a plurality of corresponding combustion chambers 128 (e.g. four combustion chambers 128, six combustion chambers 128, eight combustion chambers 128, ten combustion chambers 128, or twelve combustion chambers 128). However, the plurality of cylinders 124, the plurality of pistons 126, and the plurality of combustion chambers 128 will be referred to herein as “the cylinder 124,” “the piston 126,” and “the combustion chamber 128,” respectively, unless reference to the plurality of cylinders 124, the plurality of pistons 126, and the plurality of combustion chambers 128 is otherwise necessary. It should be understood that the structures and/or relationships discussed herein corresponding to the cylinder 124, the piston 126, and the combustion chamber 128 may be understood as also corresponding to the plurality of cylinders 124, the plurality of pistons 126, and the plurality of combustion chambers 128, respectively.

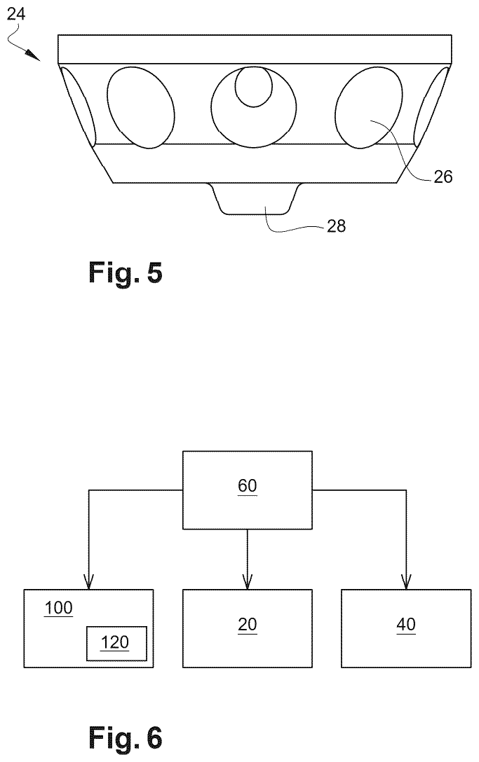

As shown in FIGS. 3 and 5, the ignition system 10 includes an injection member 20 configured to deliver fuel to the combustion chamber 128. In particular, the injection member 20 may be configured to deliver fuel to and/or to form an ignition zone 140 within the combustion chamber 128. It is contemplated that the ignition zone 140 may be understood as a location in which an ignition reaction and/or an ignition propagation is directed to, limited to, and/or confined. Directing, limiting, and/or confining an ignition reaction and/or ignition propagation to the ignition zone 140 allows the ignition system 10 to facilitate ignition of fuel within the combustion chamber 128. In examples, an area and/or diameter corresponding to the ignition zone 140 may be 50% or less of an area and/or diameter of the combustion chamber 128. In examples, the injection member 20 may be configured to be positioned within or adjacent to the ignition zone 140.

The injection member 20 is configured to receive fuel distributed from the fuel supply source of the vehicle 100. As such, the injection member 20 is configured to be in communication with the fuel supply source of the vehicle 100. In examples, the injection member 20 may include a body 22 defining a conduit (not shown) configured to receive fuel distributed from the fuel supply source. The body 22 of the injection member 20 may extend to a head 24 (may also be considered and/or referred to herein as a “nozzle 24”) configured to deliver and/or direct fuel to the combustion chamber 128 and/or the ignition zone 140. In examples, delivery of fuel by the injection member 20 may be provided in the form of a jet and/or spray of fuel. At least a portion of the injection member 20 is configured to be in communication with the combustion chamber 128 and/or the ignition zone 140. In particular, at least a portion of the head 24 of the injection member 20 may be configured to be in communication with the combustion chamber 128 and/or the ignition zone 140. At least a portion of the head 24 of the injection member 20 may be configured to extend into the combustion chamber 128 and/or the ignition zone 140. In examples, the head 24 of the injection member 20 includes a substantially cylindrical geometry. As such, it is contemplated that the head 24 of the injection member 20 includes a circumference.

Referring to FIG. 5, the head 24 of the injection member 20 defines a plurality of outlets 26 configured to deliver and/or direct fuel to the combustion chamber 128 and/or the ignition zone 140. It is contemplated that the plurality of outlets 26 may be in communication with and/or extend from the conduit of the injection member 20. The plurality of outlets 26 may be oriented circumferentially and/or radially about the head 24 of the injection member 20. In examples, one or more outlet 26 of the plurality of outlets 26 may include a substantially conical geometry. Additionally or alternatively, the remaining outlets 26 of the plurality of outlets may have a substantially cylindrical geometry. Alternatively, each outlet 26 of the plurality of outlets 26 may include a substantially conical geometry. In this manner, the plurality of outlets 26 of the head 24 of the injection member 20 are configured to increase radial contact between each jet and/or spray of fuel delivered from each corresponding outlet 26 of the plurality of outlets 26 and, thus, increase ignition propagation and combustion speed within the combustion chamber 128. Additionally, the plurality of outlets 26 of the head 24 of the injection member 20 are configured to increasing generation of swirl and/or tumble of the air-fuel mixture within the combustion chamber 128 and/or directing the air-fuel mixture away from the ignition element 40. Additionally, the plurality of outlets 26 of the head 24 of the injection member 20 are configured to enable each jet and/or spray of fuel delivered during a first ignition phase (described in further detail below) of the ignition system 10 to be arranged closer to a cylinder head (not shown) of the combustion chamber 128 and/or the power unit 120 and, thus, closer to an ignition element 40 (described in further detail below) and/or ignition zone 140 of the ignition system 10, as each jet and/or stream may be delivered with an increased width in both horizontal and vertical dimensions.

Additionally or alternatively, the head 24 of the injection member 20 may define a central outlet 28 configured to deliver and/or direct fuel to the combustion chamber 128. It is contemplated that the central outlet 28 may be in communication with and/or extend from the conduit of the injection member 20. In examples, the central outlet 28 may be oriented axially and radially offset from the plurality of outlets 26, such that the central outlet 28 is oriented centrally with respect to the plurality of outlets 26, at a position extending further into the combustion chamber 128 than the plurality of outlets 26. In examples, the central outlet 28 may include a substantially conical geometry. Alternatively, the central outlet 28 may include a substantially cylindrical geometry. In this manner, the central outlet 28 is configured to direct and/or redirect ignition propagation and, thus, reduce overheating of components within the combustion chamber 128.

As shown in FIG. 3, the ignition system 10 includes an ignition element 40 configured to ignite fuel delivered to the combustion chamber 128. In particular, the ignition element 40 may be configured to ignite fuel within and/or to form the ignition zone 140. Additionally or alternatively, at least a portion of the ignition element 40 may be configured to be positioned within or adjacent to the ignition zone 140. As such, at least a portion of the ignition element 40 is configured to be in communication with the combustion chamber 128 and/or the ignition zone 140. In examples, at least a portion of the ignition element 40 is configured to extend into the combustion chamber 128 and/or the ignition zone 140. The ignition element 40 may include a body 42 extending to a tip 44 having an ignition surface 46 and at least a portion of the tip 44 and, thus, the ignition surface 46 may extend into the combustion chamber 128 and/or the ignition zone 140. In examples, the ignition surface 46 may extend within a range of 1 mm and 10 mm into the combustion chamber 128. Accordingly, the ignition surface 46 of the ignition element 40 is configured to make sufficient contact with fuel delivered to the combustion chamber 128 to improve ignition of fuel delivered the combustion chamber 128.

In examples, the ignition element 40 may be configured to locally generate and transfer heat to the combustion chamber 128 to increase a temperature within the ignition zone 140 of the combustion chamber 128 to ignite fuel delivered to ignition zone 140 the combustion chamber 128. It is contemplated that the ignition element 40 may include a heating element (not shown), such as a metallic coil heating element, a ceramic element, and/or the like within the tip 44 of the ignition element 40 configured to generate and transfer heat. Accordingly, the ignition element 40 may be configured to function as, considered to be in the form of, and/or referred to as a “glow plug.” In examples, the ignition element 40 may be configured to increase a temperature of the combustion chamber 128 to a temperature within a range of 800° C. and 1300° C.

The ignition element 40 may include a coating (not shown) applied to the ignition surface 46 configured to facilitate and/or initiate ignition of fuel delivered to the ignition zone 140 of the combustion chamber 128. The coating may include a catalyst configured to facilitate and/or initiate ignition of fuel. In particular, the coating may include a catalyst configured to facilitate and/or initiate ignition of hydrogen at an ignition reaction temperature lower than a normal hydrogen ignition reaction temperature (i.e. direct ignition of hydrogen without usage of a catalyst). It is contemplated that the coating may be composed of one or more a noble-metal catalyst, a bimetallic catalyst, and/or the like capable of decreasing an ignition reaction temperature for ignition of hydrogen. In this manner, the ignition element 40 is configured to increase ignition propagation and combustion speed within the ignition zone 140 of the combustion chamber 128.

Alternatively, in examples, the ignition element 40 may be configured to generate an electric spark to ignite fuel. In examples in which the ignition element 40 may be configured to generate an electric spark, is contemplated that the ignition element 40 may include an electric spark element (not shown), such as an electrode and/or the like configured to generate an electric spark. Accordingly, the ignition element 40 may be configured to function as, considered to be in the form of, and/or referred to as a “spark plug.” However, reference to the ignition element 40 being configured to function as, considered to be in the form of, and/or referred to as a “glow plug” will be used herein, unless reference to the ignition element 40 being configured to function as, considered to be in the form of, and/or referred to as a “spark plug” is otherwise necessary. It is contemplated that the ignition element 40 being configured to function as and/or considered to be in the form of a “glow plug” allows for the ignition element 40 to have a greater durability than the ignition element 40 being configured to function as and/or considered to be in the form of a “spark plug.”

As shown in FIG. 6, it is contemplated that the ignition system 10 includes an electronic control unit 60 (may also be referred to herein as “control unit 60” and/or an “ECU 60”) configured to operate the ignition system 10. Additionally or alternatively, the control unit 60 may be configured to operate one or more of the power unit 120 and the vehicle 100. As such, it is contemplated that the control unit 60 may be considered to be included by one or more of the power unit 120 and the vehicle 100.

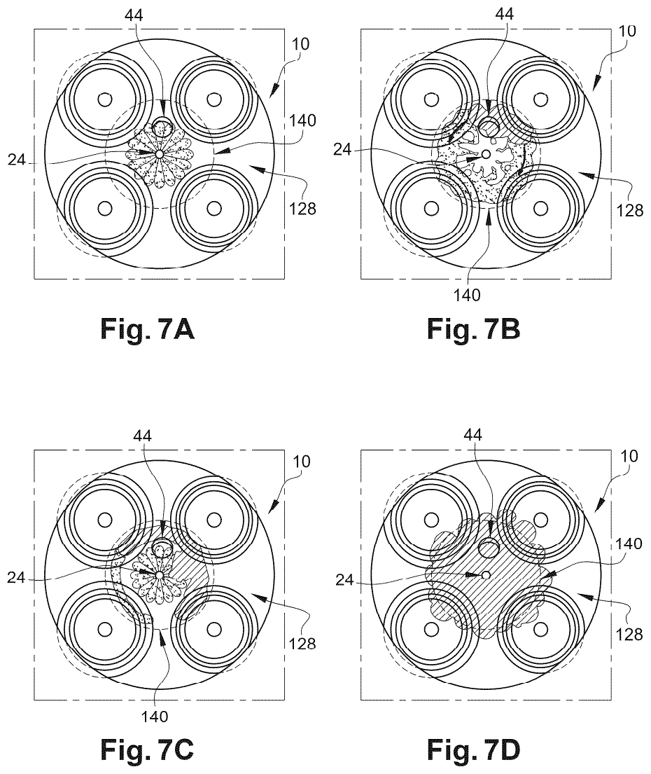

Referring to FIGS. 6-7D, the control unit 60 is configured to operate the injection member 20 and the ignition element 40 in at least a first ignition phase (may also be referred to herein as a “pilot injection phase”) (see FIGS. 7A-7B) and a second ignition phase (may also be referred to herein as a “main injection phase”) (see FIGS. 7C-7D) to facilitate ignition of fuel without use of a hydrocarbon-based fuel. The control unit 60 is configured to operate the injection member 20 in the first ignition phase at a first time. In examples, the first time of the first ignition phase may correspond to the first stroke of the combustion chamber 128. Additionally or alternatively, the first time of the first ignition phase may correspond to the second stroke of the combustion chamber 128.

The control unit 60 is configured to operate the injection member 20 to provide a first delivery of fuel to the combustion chamber 128 and/or the ignition zone 140 during the first ignition phase. The control unit 60 is configured to operate the injection member 20 to deliver a first amount of fuel in the first delivery of the first ignition phase. In examples, the first amount of fuel may be within a range of 1 mg and 10 mg of fuel. The control unit 60 is configured to operate the injection member 20 in the first ignition phase for a first duration. In examples, the first duration of the first ignition phase may be within a range corresponding to 5 crank angle degrees and 15 crank angle degrees.

The control unit 60 is configured to operate the injection member 20 in the second ignition phase at a second time. The control unit 60 is configured to operate the injection member 20 in the second ignition phase at the second time successively with respect to operation of the injection member 20 in the first ignition phase at the first time, such that the second time of the second ignition phase occurs after the first time of the first ignition phase. In examples, the second time of the second ignition phase may occur within a range corresponding to 8 crank angle degrees and 12 crank angle degrees after ignition of the first amount of fuel provided by the injection member 20 in the first delivery of fuel during the first ignition phase. Additionally or alternatively, the second time of the second ignition phase may correspond to the power stroke of the combustion chamber 128.

The control unit 60 is configured to operate the injection member 20 to provide a second delivery of fuel to the combustion chamber 128 and/or the ignition zone 140 during the second ignition phase. The control unit 60 is configured to operate the injection member 20 to deliver a second amount of fuel in the second delivery of the second ignition phase. The second amount of fuel in the second delivery of the second ignition phase is greater than the first amount of fuel in the first delivery of the first ignition phase. In examples, the second amount of fuel may be within a range of 3 mg and 150 mg of fuel. The control unit 60 is configured to operate the injection member 20 in the second ignition phase for a second duration. The second duration of the second ignition phase may be less than the first duration of the first ignition phase. In examples, the second duration of the second ignition phase may be within a range corresponding to 2 crank angle degrees and 20 crank angle degrees.

In examples, the control unit 60 may be configured to determine, set, and/or adjust (hereafter, “determine”) one or more of the first time corresponding to the first ignition phase, the second time corresponding to the second ignition phase, the first amount of fuel in the first delivery of the first ignition phase, the second amount of fuel in the second delivery of the second ignition phase, the first duration of the first ignition phase, and the second duration of the second ignition phase.

The control unit 60 may be configured to determine one or more of the first amount of fuel in the first delivery of the first ignition phase and the second amount of fuel in the second delivery of the second ignition phase in response to a measurement of load corresponding to the power unit 120. In examples, if the measurement of load corresponding to the power unit 120 is greater than or equal to a predetermined load threshold, the control unit 60 may be configured to determine an increase of one or more of the first amount of fuel in the first delivery of the first ignition phase and the second amount of fuel in the second delivery of the second ignition phase. In examples, if the measurement of load corresponding to the power unit 120 is less than or equal to the predetermined load threshold, the control unit 60 may be configured to determine a decrease of one or more of the first amount of fuel in the first delivery of the first ignition phase and the second amount of fuel in the second delivery of the second ignition phase.

Additionally or alternatively, the control unit 60 may be configured to determine the second duration of the second ignition phase in response to a measurement of the second amount of fuel in the second delivery of the second ignition phase. In examples, if the measurement of the second amount of fuel in the second delivery of the second ignition phase is greater than or equal to a predetermined fuel delivery threshold, the control unit 60 may be configured to determine an increased second duration of the second ignition phase. In examples, if the measurement of the second amount of fuel in the second delivery of the second ignition phase is less than or equal to the predetermined fuel delivery threshold, the control unit 60 may be configured to determine a decreased second duration of the second ignition phase.

It is contemplated that the ignition system 10 may include one or more sensor (not shown) configured to obtain and transmit measurements to the control unit 60 corresponding to one or more of load corresponding to the power unit 120, the first amount of fuel in the first delivery of the first ignition phase, and ignition propagation during one or more of the first ignition phase and the second ignition phase. Additionally or alternatively, it is contemplated that the control unit 60 may utilize historical data, an algorithm, and/or machine learning to make determinations corresponding to the first ignition phase and the second ignition phase.

Referring to FIG. 7A, the control unit 60 is configured to operate the ignition element 40 in the first ignition phase to generate heat and increase a temperature within the ignition zone 140 of the combustion chamber 128 in the first ignition phase. Operation of the ignition element 40 in the first ignition phase ignites the first amount of fuel provided by the injection member 20 in the first delivery of fuel during the first ignition phase. Referring to FIG. 7B, the first ignition phase allows for generation of ignition propagation prior to the second ignition phase. In FIGS. 7A-7D, it is contemplated that unignited fuel is depicted by a spotted pattern and ignited fuel is depicted by a striped pattern.

Referring to FIG. 7C-7D, the first amount of fuel ignited during the first ignition phase and/or the ignition propagation generated during the first ignition phase ignites the second amount of fuel provided by the injection member 20 in the second delivery of fuel during the second ignition phase. Additionally or alternatively, the control unit 60 may be configured to operate the ignition element 40 in the second ignition phase to generate heat and increase a temperature within the ignition zone 140 of the combustion chamber 128 in the second ignition phase. Operation of the ignition element 40 in the second ignition phase may enhance ignition of the second amount of fuel provided by the injection member 20 in the second delivery of fuel during the second ignition phase.

In this manner, ignition propagation and combustion speed within the combustion chamber 128 are improved to facilitate ignition of the air-fuel mixture in the combustion chamber 128 and, thus, the power unit 120, without use of a hydrocarbon-based fuel to facilitate ignition of the air-fuel mixture in the combustion chamber 128. Accordingly, in this manner, the system is configured for reducing emission of harmful pollutants and, thus, improving the environment and meeting criteria imposed by zero-emission vehicle standards.

According to examples of the ignition system 10, the ignition system 10 may be provided as follows:

### Example 1

An ignition system 10 configured for use on a vehicle 100, the vehicle including a power unit 120 including one or more combustion chamber 128, the ignition system 10 including: an injection member 20 configured to deliver fuel to an ignition zone 140 within the combustion chamber 128; an ignition element 40 configured to ignite fuel within the ignition zone; and a control unit 60 configured to operate the injection member 20 and the ignition element 40 in a first ignition phase including ignition of a first delivery of fuel provided to the combustion chamber 128 by the injection member 20 and a second ignition phase including ignition of a second delivery of fuel provided to the combustion chamber 128 by the injection member 20.

### Example 2

The ignition system 10 according to Example 1, wherein the control unit 60 is configured to operate the injection member 20 to deliver a first amount of fuel in the first delivery of the first ignition phase and to deliver a second amount of fuel in the second delivery of the second ignition phase.

### Example 3

The ignition system 10 according to Example 2, wherein the second amount of fuel delivered in the second delivery of the second ignition phase is greater than the first amount of fuel delivered in the first delivery of the first ignition phase.

### Example 4

The ignition system 10 according to any of Examples 1-3, wherein the control unit 60 is configured to operate the injection member 20 and the ignition element 40 in the first ignition phase at a first time and the second ignition phase at a second time.

### Example 5

The ignition system 10 according to Example 4, wherein the first time of the first ignition phase and the second time of the second ignition phase are successive.

### Example 6

The ignition system 10 according to any of Examples 4-5, wherein the first time of the first ignition phase corresponds to an intake stroke of the combustion chamber 128.

### Example 7

The ignition system 10 according to any of Examples 4-5, wherein the first time of the first ignition phase corresponds to a compression stroke of the combustion chamber 128.

### Example 8

The ignition system 10 according to any of Examples 4-7, wherein the second time of the second ignition phase corresponds to a power stroke of the combustion chamber 128.

### Example 9

The ignition system 10 according to any of Examples 1-8, wherein the injection member 20 and the ignition element 40 are configured to form the ignition zone 140 within an area corresponding to 50% or less of a diameter of the combustion chamber 128.

### Example 10

The ignition system 10 according to any of Examples 1-9, wherein the ignition element 40 extends to a tip 44 including an ignition surface 46 configured to be in contact with fuel delivered to the combustion chamber 128.

### Example 11

The ignition system 10 according to Example 10, wherein the ignition element 40 includes a coating applied to the ignition surface 46 of the tip 44 of the ignition element 40, the coating including a catalyst configured to facilitate ignition of fuel delivered to the combustion chamber (128).

### Example 12

The ignition system 10 according to any of Examples 1-8, wherein the ignition element 40 is configured to generate a spark to ignite fuel delivered to the combustion chamber 128.

### Example 13

The ignition system 10 according to any of Examples 1-12, wherein the injection member 20 extends to a head 24 defining a plurality of outlets 26, 28 configured to direct fuel to the combustion chamber 128.

### Example 14

The ignition system 10 according to Example 13, wherein the plurality of outlets 26 of the head 24 of the injection member 20 are oriented circumferentially about the head 24 of the injection member 20.

### Example 15

The ignition system 10 according to any of Examples 13-14, wherein one or more outlet 26, 28 of the plurality of outlets 26, 28 includes a conical geometry.

### Example 16

The ignition system 10 according to any of Examples 1-15, comprising an intake port 130 configured to provide air to the combustion chamber 128 and one or more of the intake port 130 and the combustion chamber 128 is configured to swirl an air-fuel mixture within the combustion chamber 128.

### Example 17

A vehicle 100 including: a power unit 120 including one or more combustion chamber 128; and the ignition system 10 according to any of Examples 1-16.

### Example 18

The vehicle 100 according to Example 17, wherein the power unit 120 includes an intake port 130 configured to deliver a flow air to the combustion chamber 128 and one or more of the intake port 130 and the combustion chamber 128 is configured to swirl an air-fuel mixture within the combustion chamber 128.

### Example 19

A method for ignition of fuel for a vehicle 100, the vehicle 100 including a power unit 120 including one or more combustion chamber 128, the method including: providing the ignition system 10 according to any of Examples 1-16; and operating the injection member 20 and the ignition element 40 in the first ignition phase including the first delivery of fuel to the combustion chamber 128 and the second ignition phase including the second delivery of fuel to the combustion chamber 128.

### Example 20

The method according to Example 19, including determining one or more of an amount of fuel and a duration of delivery of fuel delivered in the first delivery of the first ignition phase.

Although the present disclosure herein has been described with reference to particular examples, it is to be understood that these examples are merely illustrative of the principles and applications of the present disclosure.

It is intended that the specification and examples be considered as exemplary only, with a true scope of the disclosure being indicated by the following claims.

Additionally, all of the disclosed features of an apparatus may be transposed, alone or in combination, to a method and vice versa.

What is claimed is:

1. An ignition system configured for use on a vehicle, the vehicle comprising a power unit including one or more combustion chamber, the ignition system comprising:
an injection member configured to deliver fuel to an ignition zone within the combustion chamber;
an ignition element configured to ignite fuel within the ignition zone; and
a control unit configured to operate the injection member and the ignition element in a first ignition phase including ignition of a first delivery of fuel provided to the combustion chamber by the injection member and a second ignition phase including ignition of a second delivery of fuel provided to the combustion chamber by the injection member.

2. The ignition system of claim 1, wherein the control unit is configured to operate the injection member to deliver a first amount of fuel in the first delivery of the first ignition phase and to deliver a second amount of fuel in the second delivery of the second ignition phase.

3. The ignition system of claim 2, wherein the second amount of fuel delivered in the second delivery of the second ignition phase is greater than the first amount of fuel delivered in the first delivery of the first ignition phase.

4. The ignition system of claim 1, wherein the control unit is configured to operate the injection member and the ignition element in the first ignition phase at a first time and the second ignition phase at a second time.

5. The ignition system of claim 4, wherein the first time of the first ignition phase corresponds to an intake stroke of the combustion chamber.

6. The ignition system of claim 4, wherein the first time of the first ignition phase corresponds to a compression stroke of the combustion chamber.

7. The ignition system of claim 4, wherein the second time of the second ignition phase corresponds to a power stroke of the combustion chamber.

8. The ignition system of claim 1, wherein the injection member and the ignition element are configured to form the ignition zone within an area corresponding to 50% or less of a diameter of the combustion chamber.

9. The ignition system of claim 1, wherein the ignition element extends to a tip including an ignition surface configured to be in contact with fuel delivered to the combustion chamber.

10. The ignition system of claim 9, wherein the ignition element includes a coating applied to the ignition surface of the tip of the ignition element, the coating including a catalyst configured to facilitate ignition of fuel delivered to the combustion chamber.

11. The ignition system of claim 1, wherein the injection member extends to a head defining a plurality of outlets configured to direct fuel to the combustion chamber.

12. The ignition system of claim 11, wherein one or more outlet of the plurality of outlets includes a conical geometry.

13. The ignition system of claim 1, comprising an intake port configured to provide air to the combustion chamber and one or more of the intake port and the combustion chamber is configured to swirl an air-fuel mixture within the combustion chamber.

14. A vehicle comprising:
a power unit including one or more combustion chamber; and
the ignition system of claim 1.

15. A method for ignition of fuel for a vehicle, the vehicle comprising a power unit including one or more combustion chamber, the method comprising:
providing the ignition system of claim 1; and
operating the injection member and the ignition element in the first ignition phase including the first delivery of fuel to the combustion chamber and the second ignition phase including the second delivery of fuel to the combustion chamber.
